(19) United States
(12) Patent Application Publication
(10) Pub. No.: US 2022/0376331 A1
(43) Pub. Date: Nov. 24, 2022

(54) BATTERY HOUSING

(71) Applicant: FRIEDRICH BOYSEN GMBH & CO. KG, ALTENSTEIG (DE)

(72) Inventor: Felix Roller, Calw (DE)

(21) Appl. No.: 17/750,255

(22) Filed: May 20, 2022

(30) Foreign Application Priority Data
May 21, 2021 (DE) 102021113287.8

(51) Int. Cl. H01M 50/145; H01M 50/121; H01M 50/119; H01M 50/124

(52) U.S. Cl. CPC H01M 50/145; H01M 50/121; H01M 50/119; H01M 50/1245

(57) ABSTRACT

A battery housing for an electrical energy store at least sectionally defines a reception space for the electrical energy store and has at least two housing sections that are connected to one another while forming a joining point. The at least two mutually connected housing sections are produced from a sheet metal organically coated at least adjacent to the joining point and are adhesively bonded to a connection element at the joining point.

The present invention relates to a battery housing for an electrical energy store, in particular for a vehicle battery, that at least sectionally defines a reception space for the electrical energy store and that has at least two housing sections that are connected to one another while forming a joining point.

Such battery housings are, for example, used in automotive engineering to accommodate the drive battery or the starter battery in a protected manner. Battery housings of said kind are frequently produced from aluminum or from steel. For an improved corrosion protection, a battery housing can have a painting such as a cathodic dip painting (CDP), which is associated with relatively high process and logistics costs, however. A further problem is that the thermal joining processes typically used to connect two housing sections are likewise complex and/or expensive.

It is an object of the invention to specify a battery housing of said kind that can be manufactured simply and inexpensively and that nevertheless has a sufficiently high strength and tightness.

The object is satisfied by a battery housing having the features of claim 1.

In accordance with the invention, the at least two mutually connected housing sections are each produced from a sheet metal organically coated at least adjacent to the joining point and are adhesively bonded to a connection element at the joining point. The organic coating ensures a high level of corrosion protection so that no complex and/or expensive painting of the housing sections is required.

It is also not necessary to subject the battery housing to a coating process after the connection of the housing sections. Due to the adhesive connection via the connection element and the requirement for a thermal joining that is thereby omitted, the housing sections can rather already be organically coated before the carrying out of the connection process. Unlike a thermal joining, an adhesive connection via a connection element does not cause damage to or destruction of the organic coating.

The at least two mutually connected housing sections can have an organic coating that is based on a polymer material, in particular a high polymeric material. The organic coating can, for example, comprise polyvinyl chloride, polyethylene, polytetrafluoroethylene, a reactive resin such as an epoxy resin, and/or rubber. Such coatings ensure a high level of protection against aqueous and non-aqueous corrosion media and prevent the adhering of solid and pasty substances to the housing sections.

The connection element is preferably arranged between the housing sections and/or overlapping with the housing sections, in particular with a recess being formed between the mutually connected housing sections, into which recess the connection element is glued. The housing sections are therefore preferably connected to one another via the connection element, particularly preferably solely via the connection element. An overlapping arrangement allows relatively large adhesive surfaces. The recess can be a gap or the like that is filled and thus sealed by the connection element.

Provision can be made that the recess is formed between respective edges, extending in parallel with one another, of the mutually connected housing sections and the connection element has a longitudinal axis that extends in parallel with the edges. The size of the connection element can be minimized in this manner.

The mutually connected housing sections are preferably each completely produced from an organically coated sheet metal. This facilitates the manufacture since prefabricated sheet metal parts substantially coated over the full area can then be used. In general, the mutually connected housing sections can, however, also be produced from a sheet metal that is only sectionally organically coated.

In accordance with an embodiment of the invention, the mutually connected housing sections form an areal wall. This enables a particularly simple design.

The at least two mutually connected housing sections can in particular extend transversely to one another and can thereby form a wall extending over a corner. In this respect, the joining point can extend along an edge that forms the corner of the wall.

A specific embodiment of the invention provides that the wall is formed by at least three housing sections that are connected to one another while forming at least two joining points and that are produced from an organically coated sheet metal at least adjacent to the joining points, with in each case mutually adjoining housing sections of the at least three housing sections being adhesively bonded to a connection element. The battery housing can be assembled from three or more areal housing sections in this manner. A particularly simple design can thereby be achieved.

It very generally applies that the housing sections can have reinforcing structures that are formed in one piece with the housing sections, for instance beads and/or local ribs and/or regions having greater material thicknesses, and/or that are connected to the housing sections, for example separate stiffening components.

A further embodiment of the invention provides that the wall is tub-shaped and the mutually connected housing sections are side walls of the tub-shaped wall that project from a base of the tub-shaped wall. The tub-shaped wall can, for example, be fastened to a carrier component of the battery housing or of a vehicle after the electrical energy store has been arranged in the depression of the tub-shaped wall.

The connection element can be produced from a corrosion-resistant material. The connection element is preferably sectionally or completely produced from an organically coated sheet metal.

It is preferred that the mutually connected housing sections are each adhesively bonded to the connection element by means of a cold-curing adhesive. In this way, it is ensured that no thermally induced damage to the organic coating is caused by the adhesive bonding.

The mutually connected housing sections can each be adhesively bonded in a liquid-tight manner to the connection element to avoid an entry of splash water and the like into the reception space.

The battery housing can be configured for fastening to an underbody of a motor vehicle. The underbody of a motor vehicle is usually exposed to particularly harsh environmental conditions. Particularly high tightness and leak tightness requirements therefore exist for a battery housing arranged at the underbody.

The mutually connected housing sections can each additionally be connected in a form-fitting manner to the connection element. This enables a particularly stable connection. The mutually connected housing sections can in particular be connected to the connection element by means of clinching.

The invention also relates to a method of manufacturing a battery housing for an electrical energy store, in particular a battery housing designed as described above, wherein at least two housing sections are provided and are connected to one another while forming a joining point in order to form a reception space for the electrical energy store.

In accordance with the invention, housing sections that are produced from a sheet metal organically coated at least adjacent to the joining point are adhesively bonded to a connection element at the joining point. This enables a high level of corrosion protection with a simple and inexpensive manufacture. At least two housing sections can in particular be provided that are already provided with an organic coating as a coil or as a panel.

The housing sections composed of the organically coated sheet metal can be connected to the connection element by means of clinching in addition to adhesive bonding. The strength of the connection can thereby be increased.

Further developments of the invention can also be seen from the dependent claims, from the description, and from the enclosed drawings.

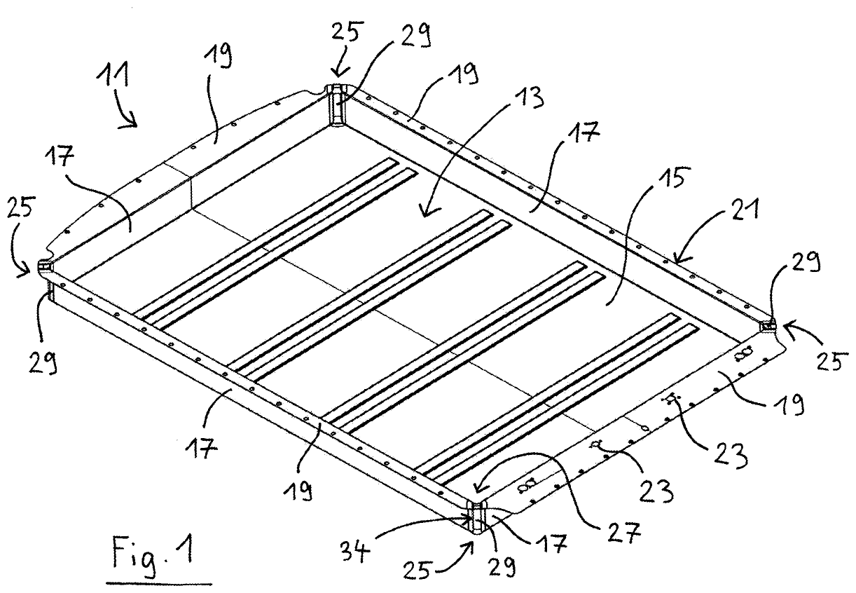

FIG. 1 is a perspective representation of a battery housing in accordance with the invention; and

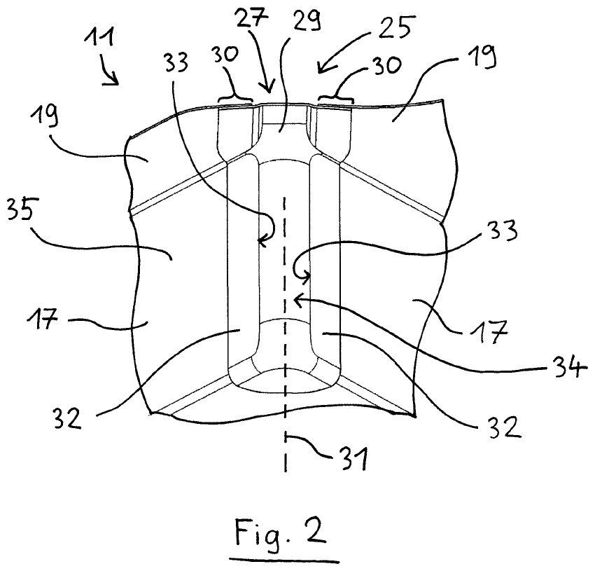

FIG. 2 is an enlarged part representation of a corner region of the battery housing in accordance with FIG. 1.

In the present embodiment, the battery housing 11 in accordance with the invention shown in FIGS. 1 and 2 is tub-shaped and defines a reception space 13 for an electrical energy store, not shown, for example for the drive battery of an electric vehicle or hybrid vehicle. The battery housing 11 comprises a plurality of areal housing sections, namely a base section 15, four sidewall sections 17 projecting from the base section 15, and four flange sections 19 projecting from the sidewall sections 17 and extending in parallel with the base section 15. The flange sections 19 extending in a common plane define a flange 21 for fastening the battery housing 11 to a carrier, not shown, such as the underbody of a motor vehicle. At least one of the flange sections 19 can be provided with leadthroughs 23 for fastening means for this purpose.

As shown, mutually adjoining sidewall sections 17 in each case extend transversely to one another and thus form four corner regions 25 of the battery housing 11. In this respect, there is an intermediate space in the form of a gap 27, into which a corner connector 29 is glued, between two mutually adjoining side wall sections 17 in each case.

One of the corner connectors 29 is shown enlarged in FIG. 2. In the present example, each of the corner connectors 29 is formed from an areal sheet metal part. It can be arranged overlapping (preferably, see overlap region 30) or edge to edge with the end regions 32 of the adjacent sidewall sections 17. Each of the corner connectors 29 is adhesively bonded to the associated end regions 32 and to the base section 15 by means of a cold-curing adhesive. As shown, each of the corner connectors 29 has a longitudinal axis 31 that extends in parallel with edges 33 of the end regions 32. A joining point 34 is thus formed in each of the corner regions 25. The sidewall sections 17 that are connected to one another and that are designed in one piece with the base section 15 form an areal and sealed wall 35.

The sidewall sections 17 are produced from an organically coated sheet meal. The base section 15, the flange sections 19, and/or the corner connectors 29 is/are preferably also produced from an organically coated sheet metal. Provision can in particular be made that the base section 15, the sidewall sections 17, and the flange sections 19 have resulted through a reshaping from a single organically coated sheet metal. Due to the organic coating of the sidewall sections 17, which can, for example, comprise a high polymeric material, no cathodic dip painting of the battery housing 11 is required. Due to the adhesive bonding of the sidewall sections 17 via the corner connectors 29, no thermal joining process is required for connecting the end regions 32 of the respective mutually adjoining sidewall sections 17 so that thermal damage to the organic coating is avoided.

To manufacture the battery housing 11 shown in FIGS. 1 and 2, an organically coated sheet metal component is provided in the form of a roll or a panel. A sheet metal component is preferably provided that has an organic coating closed over the full area. The sheet metal component is processed by a reshaping process, in particular a stamping-bending process, such that the base section 15, the side wall sections 17, and the flange sections 19 are formed. Subsequently, the corner connectors 29 are glued into the gaps 27 between the adjacent sidewall sections 17 by means of a cold-curing adhesive bonding process. After the curing of the adhesive, the battery housing 11 is ready for use. No subsequent large-area painting processes are preferably carried out. Local regions of the organic coating that have e.g. been affected by the stamping-bending process can be subjected to a surface treatment to achieve as good as possible a sealing of the battery housing 11.

To increase the strength of the connection between the sidewall sections 17, the corner connectors 29 can additionally be connected by means of a mechanical joining process such as clinching.

The organic coating gives the battery housing 11 a high protective effect against corrosion even if no additional painting is provided. Due to the corner connectors 29 glued into the gaps 27, thermal joining processes that could damage the organic coating can be dispensed with. The invention thus enables a particularly simple, fast, and inexpensive manufacture of a battery housing 11, wherein a high level of corrosion protection is ensured despite the simplified manufacture.

The present invention has indeed been explained by way of example using a tub-shaped component. However, it is understood that the concept in accordance with the invention can be applied to battery housing components for electrical energy stores, said battery housing components being shaped in any desired manner and having sections that are connected to one another by means of a join connection.

### REFERENCE NUMERAL LIST

11 battery housing
13 reception space
15 base section
17 side wall section
19 flange section
21 flange
23 leadthrough
25 corner region
27 gap
29 corner connector
30 overlap region
31 longitudinal axis
32 end region
33 edge
34 joining point
35 wall

1.-15. (canceled)

16. A battery housing for an electrical energy store, that at least sectionally defines a reception space for the electrical energy store and that has at least two housing sections that are connected to one another while forming a joining point, wherein the at least two mutually connected housing sections are each produced from a sheet metal organically coated at least adjacent to the joining point and are adhesively bonded to a connection element at the joining point.

17. The battery housing in accordance with claim 16, wherein the battery housing is configured for a vehicle battery.

18. The battery housing in accordance with claim 16, wherein the connection element is arranged between the housing sections and/or overlapping with the housing sections.

19. The battery housing in accordance with claim 16, wherein a recess is formed between the mutually connected housing sections, into which recess the connection element is glued.

20. The battery housing in accordance with claim 19, wherein the recess is formed between respective edges, extending in parallel with one another, of the mutually connected housing sections and the connection element has a longitudinal axis that extends in parallel with the edges.

21. The battery housing in accordance with claim 16, wherein the mutually connected housing sections are each completely produced from an organically coated sheet metal.

22. The battery housing in accordance with claim 16, wherein the mutually connected housing sections form an areal wall.

23. The battery housing in accordance with claim 22, wherein the at least two mutually connected housing sections extend transversely to one another and thereby form a wall extending over a corner.

24. The battery housing in accordance with claim 22, wherein the wall is formed by at least three housing sections that are connected to one another while forming at least two joining points and that are produced from an organically coated sheet metal at least adjacent to the joining points, with in each case mutually adjoining housing sections of the at least three housing sections being adhesively bonded to a connection element.

25. The battery housing in accordance with claim 22, wherein the wall is tub-shaped and the mutually connected housing sections are side walls of the tub-shaped wall that project from a base of the tub-shaped wall.

26. The battery housing in accordance with claim 16, wherein the connection element is produced from an organically coated sheet metal.

27. The battery housing in accordance with claim 16, wherein the mutually connected housing sections are each adhesively bonded to the connection element by means of a cold-curing adhesive.

28. The battery housing in accordance with claim 16, wherein the mutually connected housing sections are each adhesively bonded in a liquid-tight manner to the connection element.

29. The battery housing in accordance with claim 16, wherein the battery housing is configured for fastening to an underbody of a motor vehicle.

30. The battery housing in accordance with claim 16, wherein the mutually connected housing sections are each additionally connected in a form-fitting manner to the connection element.

31. A method of manufacturing a battery housing for an electrical energy store, wherein at least two housing sections are provided and are connected to one another while forming a joining point in order to form a reception space for the electrical energy store, wherein housing sections that are produced from a sheet metal organically coated at least adjacent to the joining point are adhesively bonded to a connection element at the joining point.

32. The method in accordance with claim 31, wherein the battery housing at least sectionally defines the reception space for the electrical energy store.

33. The method in accordance with claim 31, wherein the housing sections composed of the organically coated sheet metal are connected to the connection element by means of clinching in addition to adhesive bonding.
